(19) United States
(12) Patent Application Publication
(10) Pub. No.: US 2014/0377659 A1
(43) Pub. Date: Dec. 25, 2014

(54) ACTIVE MATERIALS FOR LITHIUM ION BATTERIES

(71) Applicant: Cabot Corporation, Boston, MA (US)

(72) Inventors: Miodrag Oljaca, Concord, MA (US); Berislav Blizanac, Acton, MA (US); Aurelien DuPasquier, Westford, MA (US); Ryan C. Wall, Albuquerque, NM (US); Arek Suszko, Albuquerque, NM (US); Kenneth Koehlert, Hollis, NH (US)

(21) Appl. No.: 14/309,309

(22) Filed: Jun. 19, 2014

Related U.S. Application Data
(60) Provisional application No. 61/837,970, filed on Jun. 21, 2013.
(60) Provisional application No. 61/837,976, filed on Jun. 21, 2013.

(51) Int. Cl. H01M 4/36; H01M 4/52; H01M 4/505; H01M 4/04; H01M 4/525; H01M 4/136; H01M 4/485; H01M 4/50; H01M 4/133; H01M 4/131

(52) U.S. Cl. CPC H01M 4/364; H01M 4/133; H01M 4/523; H01M 4/505; H01M 4/131; H01M 4/525; H01M 4/136; H01M 4/485; H01M 4/502; H01M 4/0416; H01M 2004/028
USPC 429/221; 429/231.95; 429/231.4; 429/223; 429/224; 429/231.1; 429/231.2; 429/231.3; 427/122

(57) ABSTRACT

Disclosed herein are cathode formulations comprising a lithium ion-based electroactive material having a D₅₀ ranging from 1 μm to 6 μm; and carbon black having BET surface area ranging from 130 to 700 m²/g and an OAN ranging from 150 mL/100 g to 300 mL/100 g. Also disclosed are cathode formulations comprising a first lithium ion-based electroactive material having a particle size distribution of 1 μm≦D₅₀≦5 μm, and a second lithium ion-based electroactive material having a particle size distribution of 5 μm<D₅₀≦15 μm. Cathodes comprising these active materials can exhibit a maximum pulse power in W/kg and W/L of the mixture higher than maximum pulse power of the first or second electroactive material individually, or an energy density in Wh/kg and Wh/L of the mixture higher than energy density of the first or second electroactive material individually. The cathode formulations can further comprise carbon black having BET surface area ranging from 130 to 700 m²/g. Also disclosed are cathodes comprising the cathode formulations, electrochemical cells comprising the cathodes, and methods of making the cathode formulations and cathodes.

### RELATED APPLICATIONS

This application claims priority under 35 U.S.C. §119(e) to U.S. Prov. App. No. 61/837,970, filed Jun. 21, 2013, and U.S. Prov. App. No. 61/837,976, filed Jun. 21, 2013, the disclosures of which are incorporated herein by reference.

### FIELD OF THE INVENTION

Disclosed herein are cathode formulations comprising electroactive active materials and conductive carbons, for use in lithium ion batteries.

### BACKGROUND

The ever-increasing functionality of electronic devices, requiring more processing power, higher resolution screens, more RAM memory, wireless capabilities, etc., are driving higher and higher demand for power. Miniaturization of these devices drive an even greater requirement for energy density of the energy storage systems. Currently, the energy storage of choice is the lithium ion battery, technology, which displays the best energy and power density. However, even with Li-ion battery technology, it has been increasingly more difficult to keep up with trends in consumer electronic devices for more power and energy in more compact size. On the other end of the application spectrum in terms of battery size are electric and hybrid electric applications, which similarly require relatively high power and energy in compact size and limited volume.

Accordingly, there remains a need for continued development of new cathode formulations.

### SUMMARY

One embodiment provides a cathode formulation comprising:

a lithium ion-based electroactive material having a D₅₀ ranging from 1 μm to 6 μm; and

carbon black having BET surface area ranging from 130 to 700 m²/g and an OAN ranging from 150 mL/100 g to 300 mL/100 g.

Another embodiment provides a cathode paste containing particles comprising a lithium ion-based electroactive material and a carbon black, wherein the paste further comprises:

a binder; and

a solvent,

wherein the lithium ion-based electroactive material has a D₅₀ ranging from 1 μm to 6 μm; and

wherein the carbon black has a BET surface area ranging from 130 to 700 m²/g and an OAN ranging from 150 mL/100 g to 300 mL/100 g.

Another embodiment provides a method of making a cathode, comprising:

combining particles comprising carbon black, a lithium ion-based electroactive material, and a binder in the presence of a solvent to produce a paste;

depositing the paste onto a substrate; and

forming the cathode,

wherein the electroactive material has a D₅₀ ranging from 1 μm to 6 μm, and the carbon black has a BET surface area ranging from 130 to 700 m²/g and an OAN ranging from 150 mL/100 g to 300 mL/100 g.

Another embodiment provides a cathode formulation comprising:

a first lithium ion-based electroactive material having a particle size distribution of 1 μm≦D₅₀≦5 μm; and

a second lithium ion-based electroactive material having a particle size distribution of 5 μm<D₅₀≦15 μm;

wherein the maximum pulse power in W/kg and W/L of the mixture is higher than maximum pulse power of the first or second electroactive material individually.

Another embodiment provides a cathode formulation comprising:

a first lithium ion-based electroactive material having a particle size distribution of 1 μm≦D₅₀≦5 μm; and

a second lithium ion-based electroactive material having a particle size distribution of 5 μm<D₅₀≦15 μm;

wherein the energy density in Wh/kg and Wh/L of the mixture is higher than energy density of the first or second electroactive material individually.

Another embodiment provides a cathode formulation comprising:

a first lithium ion-based electroactive material having a particle size distribution of 1 μm≦D₅₀≦5 μm;

a second lithium ion-based electroactive material having a particle size distribution of 5 μm<D₅₀≦15 μm; and carbon black having BET surface area ranging from 130 to 700 m²/g.

Another embodiment provides a cathode paste containing particles comprising a first lithium ion-based electroactive material, a second lithium ion-based electroactive material, and a carbon black, wherein the paste further comprises:

a binder; and

a solvent,

wherein:
the first lithium ion-based electroactive material has a particle size distribution of 1 μm≦D₅₀≦5 μm;
the second lithium ion-based electroactive material has a particle size distribution of 5 μm<D₅₀≦15 μm; and
the carbon black has BET surface area ranging from 130 to 700 m²/g.

Another embodiment provides a method of making a cathode, comprising:

combining particles comprising carbon black, a lithium ion-based electroactive material, and a binder in the presence of a solvent to produce a paste;

depositing the paste onto a substrate; and

forming the cathode,

wherein the lithium ion-based electroactive material comprises:
a first lithium ion-based electroactive material having a particle size distribution of 1 μm≦D₅₀≦5 μm; and
a second lithium ion-based electroactive material having a particle size distribution of 5 μm<D₅₀≦15 μm.

### BRIEF DESCRIPTION OF THE DRAWING(S)

FIG. 1 is a schematic two dimensional projection of simple cubic packing of spheres of first and second electroactive particles;

FIG. 2 is a plot of specific capacity at 5 C as a function of carbon black surface area in a cathode formulation comprising 3 wt % of various carbon black samples;

FIG. 3 schematically depicts the reactive spray process and the formation of a solid particle from an initial droplet;

FIG. 4 shows XRD patterns for the resulting powders prepared by reactive spray technology (RST) at different reactor temperatures using ultrasonic aerosol generation and in-line electrical heat source;

FIG. 5A is a plot of primary crystal size as a function of calcination time;

FIG. 5B is a plot of capacity at C/5 rate as a function of primary crystal size;

FIG. 6 is a series of SEM images at different magnification of material after the spray pyrolysis step (top, 700° C. reactor temperature) and after additional calcination (bottom, 750° C. for 4 hours in air);

FIG. 7 shows XRD patterns of LiCo_{0.33}Mn_{0.33}Ni_{0.33}O₂:a) as sprayed at 700° C., and b) after calcination at 900° C. for 2 hours in air;

FIG. 8A is a plot of discharge capacity versus C rate for electrodes containing small and large size active materials, as described in Example 2;

FIG. 8B is a plot of voltage versus discharge capacity, as described in Example 2;

FIG. 9 shows first C/5 charge-discharge voltage profiles and their derivatives (inset) of the small particle (solid lines) and large particle active materials (dotted lines);

FIG. 10 shows (a) discharge curves at different rates for the small particle and large particle materials, and (b) specific capacity as a function of discharge rate (C-rate);

FIGS. 11A and 11B show gravimetric (10A) and volumetric (10B) Ragone plots of energy vs. power for the large and small particle materials;

FIG. 12 shows electrochemical impedance spectra of formed and discharged coin-cells with either large or small sized particles;

FIGS. 13A and 13B are plots of maximum pulse power versus State of Discharge (SOD) equal to 1-SOC (State of Charge), both mass (FIG. 13A, gravimetric) and volume (FIG. 13B, volumetric) normalized;

FIG. 14 shows XRD spectra of the spinel annealed at various temperatures (left) and corresponding SEM images (right);

FIG. 15 shows XRD spectra of the as-sprayed, layer-layer powders and after 900° C./4 h calcination (left), corresponding SEM images before and after 900° C./4 h calcination (middle), and particle size distribution (right);

FIG. 16A is a voltage vs. capacity plot for the layer-layer material;

FIG. 16B is a voltage vs. capacity plot for the spinel;

FIG. 16C is a voltage vs. capacity plot for the layer-layer material;

FIG. 16D is an energy versus power plot for the layer-layer material and the blend of spinel/layer-layer.

FIG. 17A is a bar plot showing composite electrode density for the small and large particle active materials;

FIG. 17B is a plot of volumetric energy and power density of electrodes comprising small and large particle active materials;

FIG. 18 is a plot of capacity versus cycle number for large and small particle active materials;

FIG. 19 is a plot of electrode density as a function of wt % small particle active material in a blend of small and large particle materials, after full calendaring;

FIGS. 20A and 20B show mass normalized (FIG. 20A) and volume normalized (FIG. 20B) Ragone plots for pure small and large particle cathode formulations and their blends;

FIGS. 21A and 21B show plots of mass normalized (FIG. 21A) and volume normalized (FIG. 21B) maximum discharge power obtained from pulsed HPPC tests as a function of State of Charge (SOC);

FIG. 22 is a plot of coin-cell capacity (% of initial) as a function of cycle number for large and small particle active materials and their blends;

### DETAILED DESCRIPTION

Many battery applications require batteries that provide high power and energy. In lithium ion battery technology, power and energy density are, however, typically optimized in two different ways. High energy density is typically achieved by building thick electrode layers, such as by increasing the area loading of active materials to minimize the weight and volume contribution of inactive components such as separators, current collector foils, etc. To further maximize the density of the composite cathodes, particles of the active phase are typically large, e.g., approximately 10-25 μm in size. Such large particles have a low N₂ BET surface area of approximately 0.3 m²/g. This morphology is suitable for high energy design and long cycle life, as a result of good packing density in the composite electrode layer and low surface area on which detrimental side reactions could take place.

Commercially available “small” active particles have a size of approximately 2-4.5 μm, giving correspondingly higher N₂ BET surface areas approximately of 2.5 m²/g. This surface area is almost 10 times higher than the surface area of the “large” particle size materials. Consequently, packing density in the electrode layer is lower for the small particle materials. Moreover, cycle life, e.g., at higher temperatures, is not as good as with active cathode materials having low N₂ BET surface area. Thus, for most of the mobile/portable applications that require high energy density in small and restricted volumes, batteries comprising large particle active materials having correspondingly low N₂ BET surface areas are commonly employed.

Although large particles provide the advantages stated above, it has been observed that the use of large particles in thick electrode layers result in mass transport limitations in both the electrolyte and solid particle phases. For lithium ion batteries, the process of storing and releasing energy during the battery charge and discharge involves diffusion of Li ions inside the solid active material particles. Thus, the slower mobility of lithium in large particle size materials results in lower values of discharge rate (power). Considering that solid state diffusion is typically much slower than diffusion of Li+ ions in the electrolyte phase, active materials of a small particle size are better suited for power demanding applications.

Disclosed herein are cathode formulations comprising a lithium ion-based electroactive material having a D₅₀ ranging from 1 μm to 6 μm, and carbon black having BET surface area ranging from 130 to 700 m²/g and an OAN ranging from 150 mL/100 g to 300 mL/100 g. The disclosed cathode formulations couple active materials with sufficient lithium ion mobility for high energy density applications with conductive carbon blacks that help achieve maximum performance while maintaining sufficiently low surface area for suitable handling during manufacturing. In one embodiment, the electroactive material has a D₅₀ ranging from 1 μm to 6 μm, such as a D₅₀ ranging from 1 μm to 5 μm.

In one embodiment, the electroactive material comprises a mixture of two or more materials (e.g., first and second electroactive materials), each having a D₅₀ ranging from 1 μm to 6 μm or from 1 μm to 5 μm, or a first electroactive material having a D₅₀ ranging from 1 μm to 6 μm and a second electroactive material having a D₅₀ ranging from 1 μm to 5 μm.

It has also been discovered, that power density and/or energy density improved upon incorporating blends. In one embodiment, the blending of small and large active cathode particles improves power density without sacrificing energy density, where a reduction often occurs due to the presence of the small particles. In one embodiment, the maximum pulse power in W/kg and W/L of the blend is higher than maximum pulse power of the first or second electroactive material individually. In another embodiment, the energy density in Wh/kg and Wh/L of the mixture is higher than energy density of the first or second electroactive material individually.

Also disclosed herein are cathode formulations comprising active materials having a bimodal particle size distribution. Another embodiment provides:

a first lithium ion-based electroactive material having a particle size distribution of 1 μm<D₅₀≦5 μm; and

a second lithium ion-based electroactive material having a particle size distribution of 5 μm<D₅₀≦15 μm.

In one embodiment, the first electroactive material has a particle size distribution of 1 μm≦D₅₀≦5 μm, and the second electroactive material has a particle size distribution of 6 μm≦D₅₀≦15 μm. In another embodiment, the first electroactive material has a particle size distribution of 1 μm≦D₅₀≦5 μm, and the second electroactive material has a particle size distribution of 8 μm≦D₅₀≦15 μm. In another embodiment, the first electroactive material has a particle size distribution of 1 μm≦D₅₀≦5 μm, and the second electroactive material has a particle size distribution of 10 μm≦D₅₀≦15 μm.

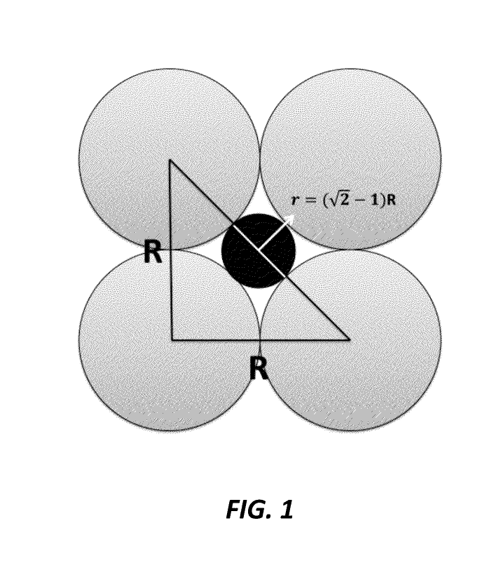

In one embodiment, the spherical radius of the second electroactive material particle is less than or equal to 0.4 the radius of the first electroactive material particle. FIG. 1 shows a two dimensional projection of a simple cubic packing of spheres. In this case, spherical particle of radius equivalent to 0.41 radius of bigger spherical particle will be able to occupy volume created by simple cubic packing of larger spheres.

In one embodiment, for co-precipitation synthesis of cathode materials, a lower size limit is less than or equal to 4-5 μm, as limited by the filtration step.

In one embodiment, the electroactive materials described herein (e.g., the first electroactive material) has a pore size of less than 15 nm, e.g., a pore size ranging from 5 nm to 15 nm, or a pore size ranging from 7 nm to 15 nm. In another embodiment, the electroactive material (e.g., the first electroactive material) has a single point adsorption total pore volume of at least 0.002 cm³/g.

In addition to the electroactive component, the cathode formulations further comprise conductive additives. In the battery industry, there are at least two competing requirements for the amount of conductive additive needed: (i) high and uniform electrical conductivity to eliminate polarization effects, which may be heightened at high current densities (voltage loss=current density×cell resistance), requiring a high amount of conductive additive, and (ii) high energy density to enable a high amount of energy to be stored in as small a volume as possible (small weight), dictating that the amount of conductive additive (diluent) be as low as possible. These two antagonistic requirements presently result in necessary trade-offs between energy and power density.

Carbon blacks have primary particles (nodules) fused together into aggregates that could further be agglomerated. Parameters used to describe carbon blacks include surface area, structure, crystallinity, purity etc. The surface area generally corresponds to the size of the primary particles and their porosity—the higher the surface area, the smaller the primary particles and the aggregates and therefore more aggregates per unit weight. Higher aggregate count per unit weight increases the probability for contact between the carbon black particles themselves and between the carbon black particles and active materials, which can result in improved electrical conductivity of the electrode layer. Thus, high surface area of carbon black can be beneficial for the electrical properties of electrode layers.

However, high surface area comes with the penalty in many other areas, such as facilitated parasitic reactions, and negative impact on cycle and calendar life. Moreover, high surface area carbon blacks may also require elevated amounts of binder (an insulator), and an accompanying decrease in the amount of the active material responsible for storing energy. During manufacturing, high surface area carbon blacks are typically more difficult to disperse and can result in increased slurry viscosity. To obtain a pastable slurry, the solids loading needs to be decreased which negatively impacts the process/manufacturing economy (solvent is expensive and never 100% recovered).

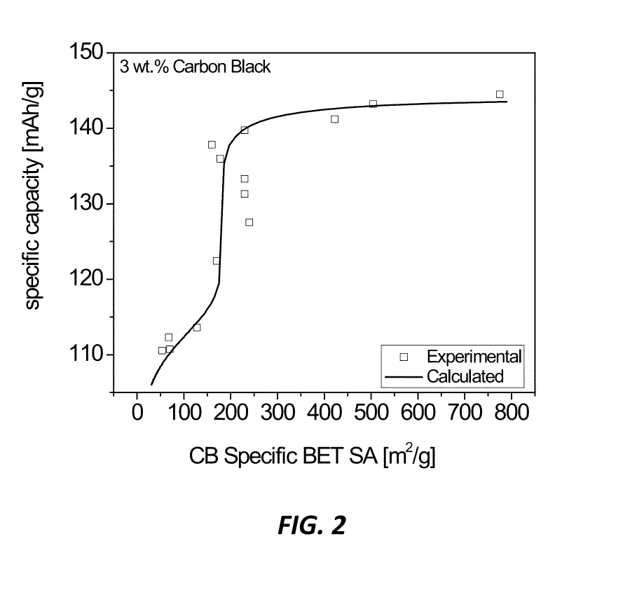

Additionally, without wishing to be bound by any theory, it is believed that in this surface area range, the battery performance as measured by capacity retention at 5 C discharge correlates with the surface area of the carbon black, as demonstrated by FIG. 2. FIG. 2 is a plot of specific capacity at 5 C as a function of carbon black surface area in a cathode formulation comprising 3 wt % of various carbon black samples. As can be seen in FIG. 2, the specific capacity generally increases with surface area in the surface area range of 130 to 700 m²/g. The plot of FIG. 2 has the shape of a typical percolation curve in which the transition occurs in the surface area range of approximately 200-300 m²/g. It can be seen that at surface area values greater than 700 m²/g, the improvement in performance is negligible.

In one embodiment, the carbon black has a BET surface area ranging from 130 to 500 m²/g, such as a surface area ranging from 130 to 400 m²/g, from 130 to 300 m²/g, from 200 to 500 m²/g, from 200 to 400 m²/g, or from 200 to 300 m²/g. BET surface area can be determined according to ASTM-D6556.

In one embodiment, the carbon black has a structure, as defined by oil adsorption number (OAN), that indicates a lesser number of imperfections via a higher degree of graphitization. OAN can be determined according to ASTM-D2414. In one embodiment, the carbon black has an OAN of less than 250 mL/100 g, e.g., an OAN ranging from 50 to 250 mL/100 g, from 100 to 250 mL/100 g, or from 100 to 200 mL/100 g.

In one embodiment, a higher degree of graphitization can be indicated by lower surface energy values, which are typically a measure of the amount of oxygen on the surface of carbon black, and thus, its hydrophobicity. Surface energy can be measured by Dynamic Water Sorption. In one embodiment, the carbon black has a surface energy (SE) less than or equal to 10 mJ/m², e.g., less than or equal to 9 mJ/m², less than or equal to 7 mJ/m², less than or equal to 6 mJ/m², less than or equal to 5 mJ/m², less than or equal to 3 mJ/m², or less than or equal to 1 mJ/m².

In one embodiment, the carbon black has a crystallite size (Lₐ) of at least 25 Å, as determined by Raman spectroscopy, where Lₐ is defined as 43.5×(area of G band/area of D band). The crystallite size can give an indication of the degree of graphitization where a higher Lₐ value correlates with a higher degree of graphitization. Raman measurements of Lₐ were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm⁻¹ and 1580 cm⁻¹, denoted as the “D” and “G” bands, respectively. It is generally considered that the D band is attributed to disordered sp² carbon and the G band to graphitic or “ordered” sp² carbon. Using an empirical approach, the ratio of the G/D bands and the Lₐ measured by X-ray diffraction (XRD) are highly correlated, and regression analysis gives the empirical relationship:

Lₐ=43.5×(area of G band/area of D band),

in which Lₐ is calculated in Angstroms. Thus, a higher Lₐ value corresponds to a more ordered crystalline structure.

In another embodiment, the carbon black has a crystallite size of at least 30 Å, at least 35 Å, at least 40 Å, at least 45 Å, or at least 50 Å.

In one embodiment, a higher % crystallinity (obtained from Raman measurements as a ratio of D and G bands) may also indicate a higher degree of graphitization. In one embodiment, the carbon black has a % crystallinity (I_{D}/I_{G}) of at least 35%, as determined by Raman spectroscopy, e.g., a % crystallinity of at least 38%, or at least 40%.

In one embodiment, the carbon black is a heat-treated carbon black. “Heat treatment” of carbon black, as used herein, generally refers to a post-treatment of a carbon black that had been previously formed by methods generally known in the art, e.g., a furnace black process. The heat treatment can occurs under inert conditions (i.e., in an atmosphere substantially devoid of oxygen), and typically occurs in a vessel other than that in which the carbon black was formed. Inert conditions include, but are not limited to, an atmosphere of inert gas, such as nitrogen, argon, and the like. In one embodiment, the heat treatment of carbon blacks under inert conditions, as described herein, is capable of reducing the number of defects, dislocations, and/or discontinuities in carbon black crystallites and/or increase the degree of graphitization.

In one embodiment, the heat treatment (e.g., under inert conditions) is performed at a temperature of at least 1000° C., at least 1200° C., at least 1400° C., at least 1500° C., at least 1700° C., or at least 2000° C. In another embodiment, the heat treatment is performed at a temperature ranging from 1000° C. to 2500° C.

In one embodiment, the heat treatment (e.g., under inert conditions) is performed at a temperature of at least 1000° C., at least 1200° C., at least 1400° C., at least 1500° C., at least 1700° C., or at least 2000° C. In another embodiment, the heat treatment is performed at a temperature ranging from 1000° C. to 2500° C. Heat treatment “performed at a temperature” refers to one or more temperatures ranges disclosed herein, and can involve heating at a steady temperature, or heating while ramping the temperature up or down, either continuously or stepwise.

In one embodiment, the heat treatment is performed for at least 15 minutes, e.g., at least 30 minutes, at least 1 h, at least 2 h, at least 6 h, at least 24 h, or any of these time periods up to 48 h, at one or more of the temperature ranges disclosed herein. In another embodiment, the heat treatment is performed for a time period ranging from 15 minutes to at least 24 h, e.g., from 15 minutes to 6 h, from 15 minutes to 4 h, from 30 minutes to 6 h, or from 30 minutes to 4 h.

In one embodiment, the electroactive material (e.g., a sum of the first and second electroactive materials) is present in the cathode formulation in an amount of at least 80% by weight, e.g., an amount of at least 90%, an amount ranging from 80% to 99%, or an amount ranging from 90% to 99% by weight, relative to the total weight of the cathode formulation.

For blends, in one embodiment the second electroactive material is present in an amount ranging from 10 wt % to 50 wt % by weight, relative to the total weight of the electroactive material (e.g., the sum of the first and second electroactive materials).

In one embodiment, the electroactive material is a lithium ion-based compound. Exemplary electroactive materials include those selected from at least one of:
LiMPO₄, wherein M represents one or more metals selected from Fe, Mn, Co, and Ni;
LiM′O₂, wherein M′ represents one or more metals selected from Ni, Mn, Co, Al, Mg, Ti, V, Cr, Fe, Zr, Ga, and Si;
Li(M″)₂O₄, wherein M″ represents one or more metals selected from Ni, Mn, Co, Al, Mg, Ti, V, Cr, Fe, Zr, Ga, and Si (e.g., Li[Mn(M″)]₂O₄); and
Li₁₊ₓ(Ni_{y}Co_{1-y-z}Mn_{z})₁₋ₓO₂, wherein x ranges from 0 to 1, y ranges from 0 to 1 and z ranges from 0 to 1.

In one embodiment, the electroactive material is selected from at least one of LiNiO₂; LiNiₓAl_{y}O₂ where x varies from 0.8-0.99, y varies from 0.01-0.2, and x+y=1; LiCoO₂; LiMn₂O₄; Li₂MnO₃; LiNi_{0.5}Mn_{1.5}O₄; LiFeₓMn_{y}Co_{z}PO₄ where x varies from 0.01-1, y varies from 0.01-1, z varies from 0.01-0.2, and x+y+z=1; LiNi_{1-x-y}MnₓCo_{y}O₂, wherein x ranges from 0.01 to 0.99 and y ranges from 0.01 to 0.99; and layer-layer compositions containing an Li₂MnO₃ phase or a LiMn₂O₃ phase.

In one embodiment, the electroactive material is selected from at least one of Li₂MnO₃; LiNi_{1-x-y}MnₓCo_{y}O₂ wherein x ranges from 0.01 to 0.99 and y ranges from 0.01 to 0.99; LiNi_{0.5}Mn_{1.5}O₄; Li₁₊ₓ(Ni_{y}Co_{1-y-z}Mn_{z})₁₋ₓO₂, wherein x ranges from 0 to 1, y ranges from 0 to 1 and z ranges from 0 to 1; and layer-layer compositions containing at least one of an Li₂MnO₃ phase and an LiMn₂O₃ phase.

Cathodes are the performance limiting component in Li-ion batteries because their capacity (^{˜}160 mAh/g) does not match the anode capacity (320 mAh/g for graphite). It has been discovered that the use of certain Mn rich formulations as active materials result in cathodes having a capacity approaching 280 mAh/g, and a gravimetric energy around 900 Wh/kg. However, these materials have low charge and discharge rate capability, causing them to lose their energy advantage even at moderate discharge rates of 2 C. Another drawback of these materials is that they display a wide voltage swing from 4.8 to 2.0V during discharge.

Accordingly, one embodiment provides a mixture of active materials comprising: a nickel-doped Mn spinel, which has a high and flat discharge voltage around 4.5 V and a high power capability; and a layer-layer Mn rich composition, which makes it possible to increase discharge voltage and power capability. In one embodiment, the nickel-doped Mn spinel has the formula LiNi_{0.5}Mn_{1.5}O₄, and the layer-layer Mn rich composition contains a Li₂MnO₃ or a LiMn₂O₃ phase, and mixtures thereof.

In one embodiment, the electroactive material comprises a first electroactive material having a D₅₀ ranging from 1 μm to 5 μm and a second electroactive material having a D₅₀ ranging from 1 μm to 6 μm, wherein:

the first electroactive material has the formula aLi₂MnO₃:(1−a)LiMO₂, wherein a ranges from 0.1 to 0.9 and M is one or more metals selected from Mn, Ni, and Co; and the second electroactive material has the formula LiNi_{0.5}Mn_{1.5}O₄.

In one embodiment, the cathode formulation further comprises a binder. Exemplary binder materials include but are not limited to fluorinated polymers such as poly(vinyldifluoroethylene) (PVDF), poly(vinyldifluoroethylene-co-hexafluoropropylene) (PVDF-HFP), poly(tetrafluoroethylene) (PTFE), polyimides, and water-soluble binders such as poly(ethylene) oxide, polyvinyl-alcohol (PVA), cellulose, carboxymethylcellulose (CMC), starch, hydroxypropylcellulose, regenerated cellulose, polyvinyl pyrrolidone (PVP), and copolymers and mixtures thereof. Other possible binders include polyethylene, polypropylene, ethylene-propylene-diene terpolymer (EPDM), sulfonated EPDM, styrene-butadiene rubber (SBR), and fluoro rubber and copolymers and mixtures thereof.

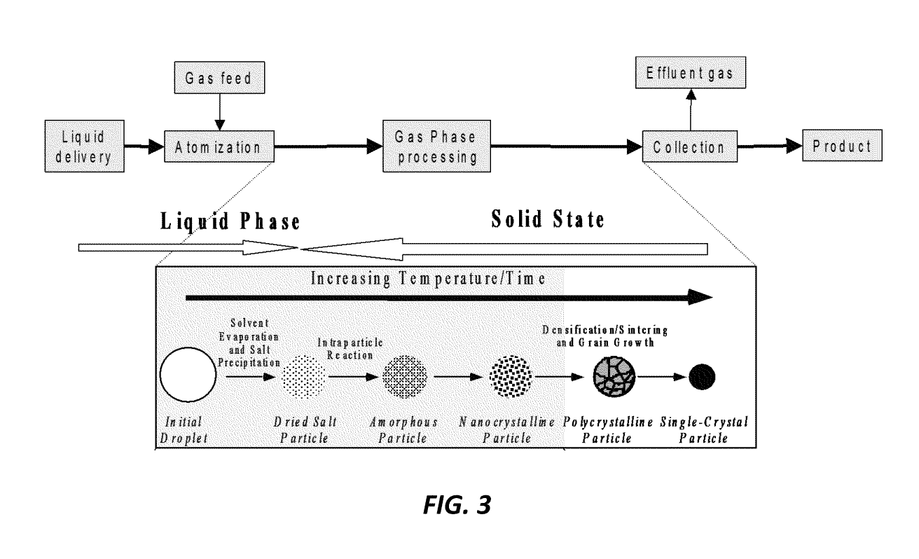

In one embodiment, the active materials are prepared by reactive spray technology (RST). In one embodiment, reactive spray technology is performed as described in U.S. Pat. No. 6,770,226, the disclosure of which is incorporated herein by reference. Other methods for performing RST are disclosed herein. Reactive spray technology combines both liquid phase and solid state processing. FIG. 3 schematically depicts the reactive spray process and the formation of a solid particle from an initial droplet. The processing starts with a liquid formulation that contains either dissolved or suspended reagents, which act as precursors to the final product or as supports. The liquid (“liquid delivery”), together with a gas (“gas feed”), is then fed to an atomization unit where the liquid is converted into an aerosol. The gas stream containing the aerosol is then heated in a gas phase processing unit to effect the physical and chemical conversion of the droplets to the final powder. FIG. 3 shows the liquid to solid state phase change over the course of increasing temperature/time (initial droplet→dried salt particle→amorphous particle→nanocrystalline particle→polycrystalline particle→single-crystal particle). The final powder is separated from the gas stream using conventional powder collection methods (“collection”), leaving only a gaseous effluent (no liquid effluent to be disposed). The final powder microstructure (“product”) and composition depends on the residence time, temperature, the reactive nature of droplet components and the composition of the gas. The physical and/or chemical evolution of the particles can be arrested at any stage by quenching of the reaction media, allowing the use of this process to produce a wide variety of materials and compositions combined with unique microstructures and morphologies.

Another embodiment provides a cathode formulation comprising, consisting essentially of, or consisting of:

a lithium ion-based electroactive material having a D₅₀ ranging from 1 μm to 6 μm; and

carbon black having BET surface area ranging from 130 to 700 m²/g and an OAN ranging from 150 mL/100 g to 300 mL/100 g.

Another embodiment provides a cathode formulation comprising, consisting essentially of, or consisting of:

a lithium ion-based electroactive material having a D₅₀ ranging from 1 μm to 6 μm; and

carbon black having BET surface area ranging from 130 to 700 m²/g and an OAN ranging from 150 mL/100 g to 300 mL/100 g; and

a binder.

Another embodiment provides a cathode formulation comprising, consisting essentially of, or consisting of:

a first lithium ion-based electroactive material having a particle size distribution of 1 μm≦D₅₀≦5 μm;

a second lithium ion-based electroactive material having a particle size distribution of 5 μm<D₅₀≦15 μm; and

carbon black having BET surface area ranging from 130 to 700 m²/g.

Another embodiment provides a cathode formulation comprising, consisting essentially of, or consisting of:

a first lithium ion-based electroactive material having a particle size distribution of 1 μm≦D₅₀≦5 μm;

a second lithium ion-based electroactive material having a particle size distribution of 5 μm<D₅₀≦15 μm;

carbon black having BET surface area ranging from 130 to 700 m²/g; and

a binder.

In one embodiment, the cathode formulation can take the form of a paste or slurry in which particulate electroactive material and carbon black are combined in the presence of a solvent. In another embodiment, the cathode formulation is a solid resulting from solvent removal from the paste/slurry.

In one embodiment, the formulation is a particulate cathode formulation. In one embodiment, “particulate” refers to a powder (e.g., a free-flowing powder). In one embodiment, the powder is substantially free of water or solvent, such as less than 10%, less than 5%, less than 3%, or less than 1% water or solvent.

In one embodiment, the carbon black is homogeneously interspersed (uniformly mixed) with the electroactive material, e.g., the lithium-ion based material. In another embodiment, the binder is also homogeneously interspersed with the carbon black and electroactive material.

Another embodiment comprises method of making a cathode, comprising:

combining particles comprising carbon black, a lithium ion-based electroactive material, and a binder in the presence of a solvent to produce a paste;

depositing the paste onto a substrate; and

forming the cathode,

wherein the electroactive material has a D₅₀ ranging from 1 μm to 6 μm, and the carbon black has a BET surface area ranging from 130 to 700 m²/g and an OAN ranging from 150 mL/100 g to 300 mL/100 g.

Another embodiment comprises method of making a cathode, comprising:

combining particles comprising carbon black, a lithium ion-based electroactive material, and a binder in the presence of a solvent to produce a paste;

depositing the paste onto a substrate; and

forming the cathode,

wherein the lithium ion-based electroactive material comprises:
a first lithium ion-based electroactive material having a particle size distribution of 1 μm≦D₅₀≦5 μm; and
a second lithium ion-based electroactive material having a particle size distribution of 5 μm<D₅₀≦15 μm.

In one embodiment, the one embodiment, the paste is the product of combining particles comprising electroactive material with carbon black and binder in the presence of a solvent. In one embodiment, the paste has a sufficiently high solids loading to enable deposition onto a substrate while minimizing the formation of inherent defects (e.g., cracking) that may result with a less viscous paste (e.g., having a lower solids loading). Moreover, a higher solids loading reduces the amount of solvent needed.

The particles can be combined in the solvent in any order so long as the resulting paste is substantially homogeneous, which can be achieved by shaking, stirring, etc. The particles can be formed in situ or added as already formed particles having the domain sizes disclosed herein. “Solvent” as used herein refers to one or more solvents. Exemplary solvents include e.g., N-methylpyrrolidone, acetone, alcohols, and water.

In one embodiment, the method comprises depositing the paste onto a substrate, such as a current collector (e.g., an aluminum sheet), followed by forming the cathode. In one embodiment, “forming the cathode” comprises removing the solvent. In one embodiment, the solvent is removed by drying the paste either at ambient temperature or under low heat conditions, e.g., temperatures ranging from 20° to 100° C. The method can further comprise cutting the deposited cathode/AI sheet to the desired dimensions, optionally followed by calendaring.

Another embodiment provides a cathode paste containing particles comprising a lithium ion-based electroactive material and a carbon black, wherein the paste further comprises:

a binder; and

a solvent,

wherein the electroactive material has a D₅₀ ranging from 1 μm to 6 μm, and the carbon black has a BET surface area ranging from 130 to 700 m²/g and an OAN ranging from 150 mL/100 g to 300 mL/100 g.

Another embodiment provides a cathode paste containing particles comprising a first lithium ion-based electroactive material, a second lithium ion-based electroactive material, and a carbon black, wherein the paste further comprises:

a binder; and

a solvent,

wherein:
the first lithium ion-based electroactive material has a particle size distribution of 1 μm≦D₅₀≦5 μm;
the second lithium ion-based electroactive material has a particle size distribution of 5 μm<D₅₀≦15 μm; and
the carbon black has BET surface area ranging from 130 to 700 m²/g.

Another embodiment provides a cathode paste consisting essentially of or consisting of the lithium ion-based electroactive material(s), the carbon black, the binder, and the solvent.

One embodiment provides a cathode comprising the cathode formulation. The cathode can further comprise a binder and a current collector. In one embodiment, the active material is a high voltage cathode with the charging cut-off voltage of 4.95 V versus Li-metal reference electrode. In one embodiment, the cathode has a thickness of at least 10 μm, e.g., a thickness of at least 30 μm. Another embodiment provides an electrochemical cell comprising the cathode, such as a lithium ion battery.

In one embodiment, an electrochemical cell comprising the disclosed cathode materials provides one or more of improvements selected from power performance, energy performance, inertness toward carbon corrosion oxidation, inertness toward carbon and/or electrolyte oxidation, and improved percolation behavior.

### EXAMPLES

### Example 1

This Example describes the preparation of LiNi_{0.33}Co_{0.33}Mn_{0.33}O₂ by reactive spray technology, as described in U.S. Pat. No. 6,770,226, the disclosure of which is incorporated herein by reference. The precursors were Ni(NO₃).26H₂O, Co(NO₃)26H₂O (supplier), and Mn nitrate. Solutions were atomized by using either a 1.65 MHz submerged ultrasonic spray generator or air-assist nozzles to produce droplets that were carried by a carrier gas into a high-temperature reactor that can be heated internally or externally. The reactor temperature was varied from 600° C. to over 1500° C. by controlling reactor input energy and design. The residence times in the reactor zone varied from <100 ms to ^{˜}10 sec. The overall solution solids loading of the nickel, cobalt, manganese and lithium components was 5 wt. %. The as-produced active material powders were alternatively post-treated at a temperature of 900° C. for 4 h under air atmosphere.

The crystal structure of the synthesized powders was carried out using X-ray diffractometry (XRD, Bruker D-8 Advance instrument) using Ni-filtered Cu—Kα radiation at 40 kV/40 mA, within 10-90 degrees 2-theta range. The analysis was performed using the TOPAS software and Rietveld's structure refinement method.

Powder morphology was studied using scanning electron microscopy (Hitachi S-5200 field emission SEM), generally operated at an accelerating voltage of 2.0 kV, coupled with a PGT EDS system and PGT Spirit software for elemental mapping and EDS.

BET surface area and porosity of each sample was measured by multi-point Nitrogen adsorption/desorption cycles in a Micromeritics Tristar 3000 apparatus. Each sample was first degassed in vacuum at 200° C. for 2 hours. A UHP N2 gas was used in the measurement.

Particle size distribution analyses were performed on BlueWave particle size analyzer. A sample (0.20 g) is mixed with 50 ml D.I. water and 3 drops of Darvan C surfactant. The resulting solution is sonicated for 3 minutes with a Branson 450 before loading.

Unless described otherwise, electrode slurries were dispersed in NMP using a SPEX mill with two zirconia media for 30 minutes. The electrodes were dried at 80° C. for ^{˜}15 minutes, then at least 4 h at 100° C. under vacuum prior to coin-cell assembly in Ar-filled glove-box (MBraun). A constant mass loading of 9 mg/cm² corresponding to a capacity loading of ^{˜}1.5 mAh/cm² was used for all the electrochemical measurement reported herein. Electrodes were calendered to a thickness of ^{˜}40 microns resulting in porosity of 15-20%. 15 mm calendered cathode discs where tested in 2032 coin-cells (Hosen) versus lithium anode. Whatman GF/D fiberglass separator and EC-DMC-EMC-VC1%, LiPF₆ 1M electrolyte (Novolyte, <20 ppm water) were used.

The initial charge/discharge capacities of the samples were measured through cycling in the 2.8-4.3 V potential range at a constant current density of 0.2 C. Capacity versus current curves were generated with constant current charging of C/2 then constant voltage of 4.3V with current cutoff of C/50, and discharge rates of C/5, C/2, 1 C, 2 C, 5 C and in some cases 10 C, 15 C, 20 C. The cycle performances of the cathode powders at an elevated temperature of 60° C. were measured at a constant current density of 0.5 C. Electrochemical impedance measurements were performed on the coin-cells with an EG&G 2273 using PowerSine software, in the 1 MHz-10 mHz range and 10 mV signal amplitude.

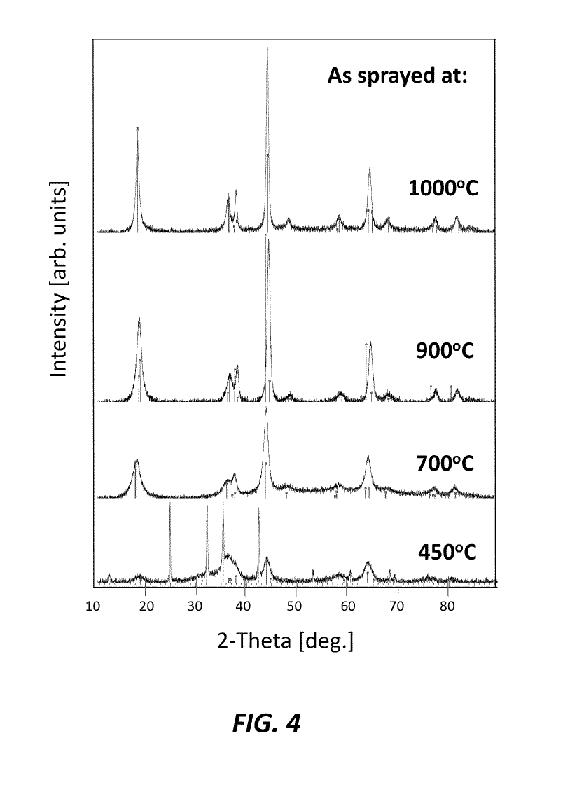

FIG. 4 shows XRD patterns for the resulting powders prepared by RST at different reactor temperatures using ultrasonic aerosol generation and in-line electrical heat source. For powders made at lower reactor temperature (450° C.) decomposition of nitrate precursors was incomplete and a significant amount of the precursors remained un-decomposed as determined by TGA analysis (not shown). Powders were also only partially converted into the right crystal phase, and resembled more a rock-salt phase instead of the crystal layered phase. For samples made at higher reactor temperatures, the XRD analysis and Rietveld refinement indicates a pure Li[Ni_{1/3}Co_{1/3}Mn_{1/3}]O₂ phase with no peaks from individual oxides. Based on the Rietveld analysis, materials made by RST belongs to the R-3m space group with lattice parameters a=2.863 Å, c=14.234 Å and an average grain size (from XRD) ranging from 46 nm for materials made at 700° C. reactor temperature to 265 nm for powders made at 1000° C.

The powders prepared by RST had a morphology consisting of porous spherical particles formed by agglomeration of smaller particulate aggregates 20-50 nm in size. The particle size during the RST processing can be controlled by solution concentration, droplet size and other process parameters. Each droplet will become a particle and a simple correlation between process conditions and final particle size distribution was established. The results of physical characterization of as-sprayed materials (after RST step) are provided in Table 1.

TABLE 1

| | N2 | N2 BET Pore | | | | |
|---|---|---|---|---|---|---|
| Spray | BET | Volume | Dₘₑₐₙ | | | |
| pyrolysis | SA | (single point) | ᵥₒₗᵤₘₑ | D₁₀ | D₅₀ | D₉₀ |
| at | m²/g | cc/g | microns | microns | microns | microns |
| 450° C. | 23.5 | 0.054 | 1.704 | 0.585 | 1.293 | 3.364 |
| 700° C. | 72.7 | 0.191 | 1.518 | 0.482 | 1.240 | 2.904 |
| 900° C. | 31.8 | 0.141 | 1.444 | 0.322 | 1.174 | 2.884 |
| 1000° C. | 20.5 | 0.106 | 1.126 | 0.252 | 1.064 | 1.984 |

Over the entire reactor temperature range, the surface area ranged from 20 to 70 m²/g. From Table 1, it can be seen that the resulting spherical particles showed significant amounts of internal porosity by the total pore volume from single point N₂ BET adsorption measurements. All samples had particle size less than 4-5 μm, which is the typical lower limit of a co-precipitation process known in the art. In general, higher temperatures resulted in increased particle densification (as schematically shown in FIG. 1) and reduction in both particle size and internal porosity as shown in Table 1.

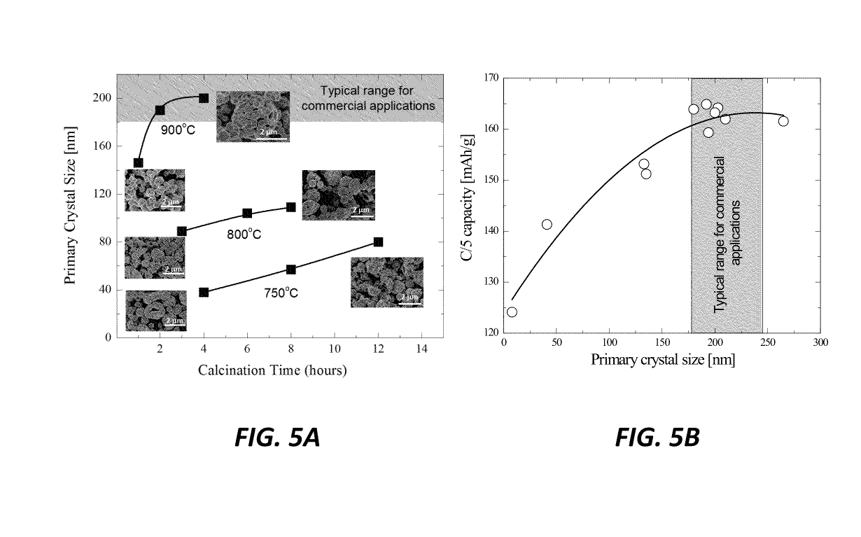

The crystallinity of the powders could be improved by increasing the reactor temperature and residence time, potentially opening possibility for one step continuous manufacturing process utilizing Reactive Spray Technology. One of the general attributes of the RST process is an intimate and homogenous precursor mixing (including Lithium) at the atomic level. The elemental components are in close proximity to one another, thus, not requiring long heat treatment steps to overcome slow solid state diffusion. This feature of materials made by using RST is expected to result in a shortening of the heat treatment step in cases where thermal post-treatment is needed. Moreover, the optional post treatment step can typically be performed at much lower temperatures due to the element mixing at the atomic level and short diffusion paths. The effect of calcination time and the calcination temperature on the size of the primary crystals is shown in FIG. 5A.

A correlation between the primary crystal size and the reversible Lithium capacity at C/5 rate is shown in FIG. 5B. It was found that C/5 electrochemical capacity of the electroactive powders increases with crystal size up to a value of ^{˜}165 mAh/g for crystal size of ^{˜}200 nm, but no further improvement was observed at larger crystal size. The optimal size of the primary crystals ranged from 180-220 nm for which the reversible capacity was maximized at ^{˜}165 mAh/g.

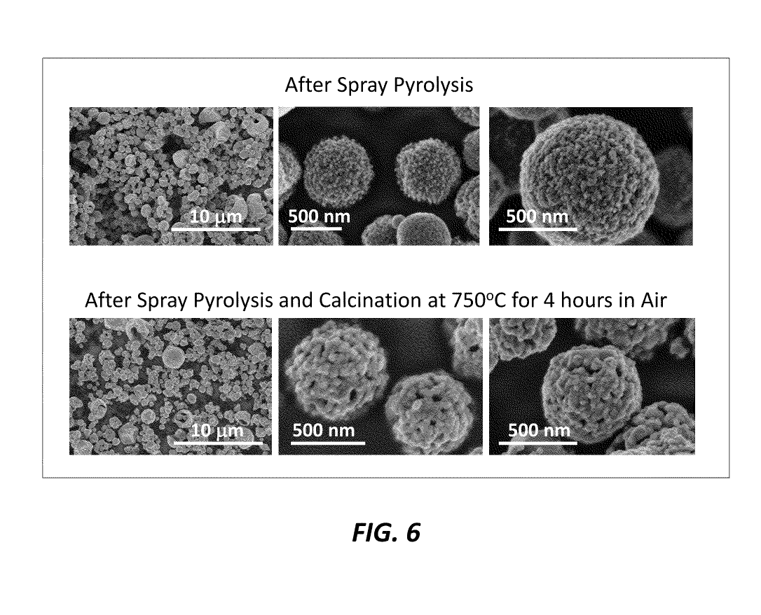

FIG. 6 shows SEM images at different magnification of material after the spray pyrolysis step (top, 700° C. reactor temperature) and after additional calcination (bottom, 750° C. for 4 hours in air). As can be seen from FIG. 6, particle size and morphology remained largely unchanged after the optional post-treatment step, which opens the possibility of unique powder morphologies. Higher magnification SEM images reveal that smaller aggregates within the particle were more crystalline after the post-treatment step. When calcination was conducted at 900° C., a desirable crystal size was achieved after only 2-4 hours, establishing the benefit of RST of significantly reducing post-treatment time.

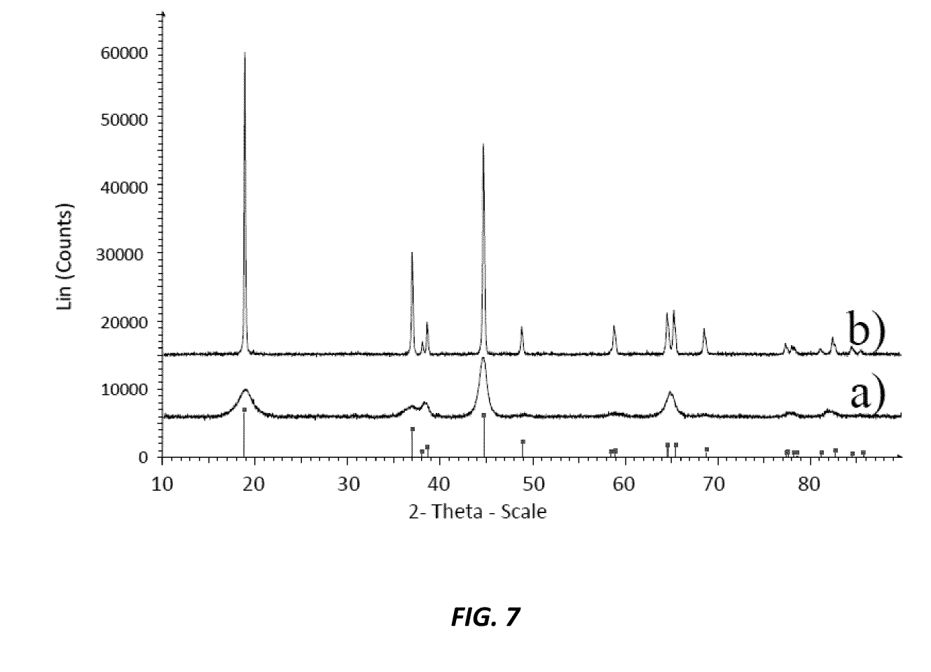

FIG. 7 shows XRD patterns of LiCo_{0.33}Mn_{0.33}Ni_{0.33}O₂:a) as sprayed at 700° C., and b) after calcination at 900° C. for 2 hours in air. The theoretical XRD peaks are shown adjacent the x-axis. FIG. 7 indicates that the correct crystal phase was achieved after the RST step. Post-treatment therefore resulted only in improvement in crystallinity through the primary crystal growth. No crystalline impurities of any kind were detected after post-treatment. The Co:Mn:Ni ratio was virtually 1 with coefficients differences of +/−0.01.

Basic physical properties of materials sprayed at 700° C. reactor temperature before and after post-treatment at 900° C. for 4 hours in air are shown in Table 2. For comparison, properties of powders made by co-precipitation method are also provided.

TABLE 2

| | | Pore | | | |
|---|---|---|---|---|---|
| | | volume from | | | |
| | N₂ | single point | | | |
| | BET | N₂ BET | | | |
| | SA | adsorption | D₁₀ | D₅₀ | D₉₀ |
| Material | m²/g | cc/g | microns | microns | microns |
| Sprayed at 700° C. | 72.7 | 0.191 | 0.48 | 1.24 | 2.90 |
| Post-treated at 900° C. | 2.05 | 0.0065 | 1.14 | 2.66 | 4.87 |
| for 4 hours in air | | | | | |
| Co-precipitation | 0.27 | 0.0013 | 5.74 | 10.93 | 18.72 |

The surface area of as sprayed material (72.7 m²/g) was reduced to 2.05 m²/g after calcination at 900° C. in air for 4 hours. The particle size increased somewhat, but the morphology overall remained very similar to the morphology of the starting as-sprayed powder. As previously shown in FIG. 5A, calcination at high temperature resulted in an increase in primary crystal size, which also reduces internal porosity within the spherical agglomerates. After additional heat treatment at 900° C. for 4 hours, the porosity was reduced to only 3% of the porosity of the initial powder after the RST process step. However, the resulting porosity is still almost five times higher than the total porosity (i.e. pore volume) for LiCo_{0.33}Mn_{0.33}Ni_{0.33}O₂ powder made by co-precipitation method.

Without wishing to be bound by any theory, it can be expected that an increase in (electrochemically active) surface area combined with internal porosity should result in facilitated reaction kinetics and mass transport (i.e. ionic conductivity). The internal pores can act as “highways” for the electrolyte making it accessible to the entire electrochemically active surface area at rates significantly faster than if Li transport was taking place throughout the solid phase (i.e. in large, non-porous particles).

### Example 2

This Example provides a comparison between electrodes comprising small particle active materials versus large particle active materials. Because the surface area of the small particle material is almost 10 times higher than the surface area of the large particle material, it was believed that such electrodes would result in a lower packing density in the electrode layer, and poorer cycle life especially at higher temperatures.

The small particle active material used in this Example was a powder of formula LiNi_{0.33}CO_{0.33}Mn_{0.33}O₂ made by the method described in Example 1 where RST processing was performed at 700° C. and post-treated at 900° C. in air for 4 hours. The large particle material was made by conventional co-precipitation, available commercially. Table 3 lists the size and surface area properties for large and small particle size materials:

TABLE 3

| active material | N₂ BET SA (m²/g) | Dₘᵥ (μm) | D₅₀ (μm) | D95 (μm) |
|---|---|---|---|---|
| “large” | 0.3 | 1.2 | 11 | 22 |
| “small” | 2.5 | 2 | 1.7 | 4.5 |

Both morphologies were tested independently to determine their baseline performance. Electrochemical performance was evaluated in 2032 coin cell configuration. The working electrode/cathode consisted of active material (AM), binder (PVDF), and carbon black (CB, LITX200H™, available from Cabot Corporation) in the ratio given in the Table 4 below. Cathode loading was 1.5 mAh/cm², assuming 150 mAh/g capacity of electroactive material. The counter electrode was Li-metal. Further details of the electrode formulation and electrochemical test configuration are provided in Table 4.

TABLE 4

| | |
|---|---|
| Cell Configuration | Coin Cell 2032 |
| Anode | Li-Metal |
| Cathode | AM:CB:Binder = 94:3:3 (small); 98:1:1 (large) |
| Cathode Loading | 1.5 mAh/cm² |
| Electrolyte | EC-DMC-EMC (1:1:1); VC 1%, 1M LiPF₆ |
| Temperature | 25° C. |

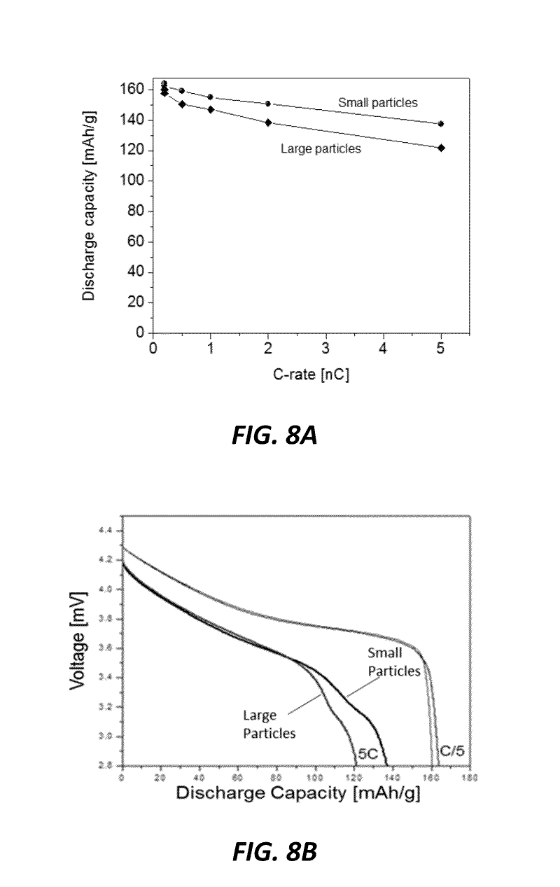

FIG. 8A is a plot of discharge capacity versus C rate for electrodes containing small and large size active materials. FIG. 8B is a plot of voltage versus discharge capacity. As can be seen from FIGS. 8A and 8B, cathodes comprising small particle active materials provide better power performance.

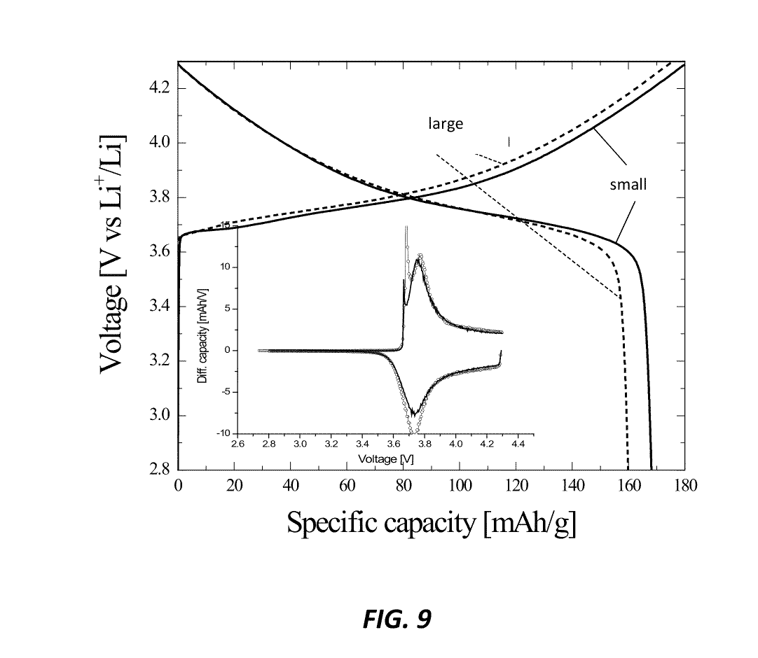

FIG. 9 shows first C/5 charge-discharge voltage profiles and their derivatives (inset) of the small particle (solid lines) and large particle active materials (dotted lines). The C/5 voltage profile of the small particle active material is similar to the one of the large particle material but with a higher capacity, typically in the range 165-168 mAh/g versus 159-160 mAh/g for the large particle material. The derivative of voltage profiles are similar, with one pair of reversible peaks below 4V vs. Li⁺/Li, indicating that same redox couple (Ni²⁺/Ni⁴⁺) is active in both cases.

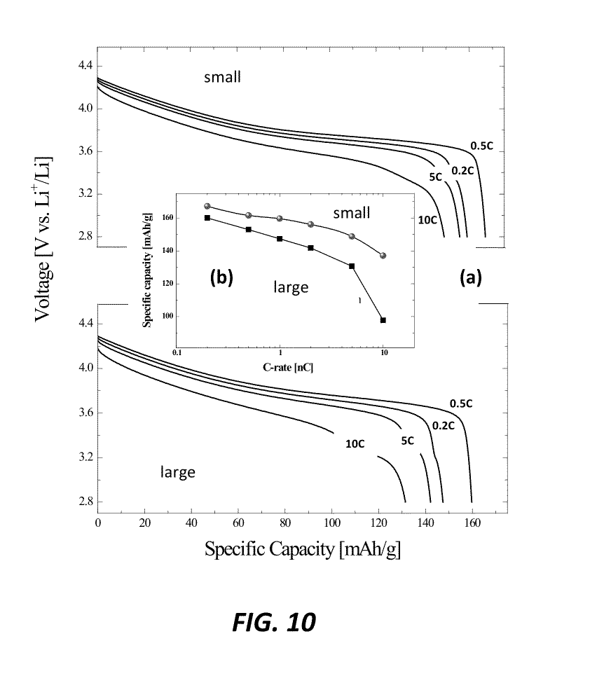

FIG. 10 shows (a) discharge curves at different rates for the small particle and large particle materials, and (b) specific capacity as a function of discharge rate (C-rate). The active phase loading was 1.5 mAh/cm². The shape of the curves is similar for both materials, including a similar voltage profile in the initial stages of Li intercalation into the active material. This indicates a similar resistance to electron flow and further confirms that optimal loading of conductive additive depends on the morphology of the active material. The differences in polarization curves between the two are amplified in the later stages of discharge, dominantly under the influence of mass transport limitations in the electrode layer. The capacity vs. C-rate plot (b) shows the benefit of small particle materials. While the capacity of 137 mAh/g at 10 C discharge rate is maintained in electrodes utilizing the small particle materials, the large particle materials at the same electrode loading is only delivering 97 mAh/g. Thus, a greater than 40% improvement is achieved with the small particle material.

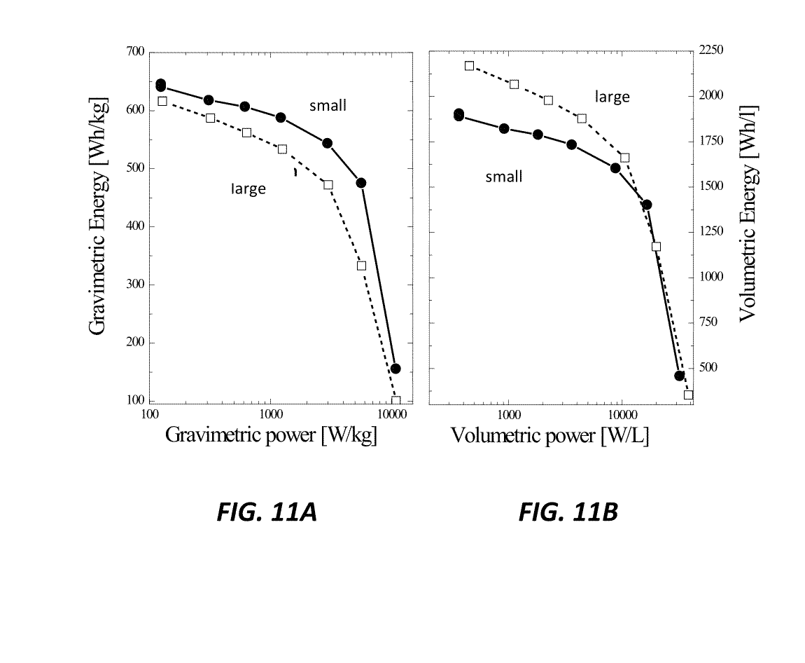

FIGS. 11A and 11B show gravimetric (11A) and volumetric (11B) Ragone plots of energy vs. power for the large and small particle materials. Based on the mass normalized Ragone plot of FIG. 11A, the small particle material demonstrates superior energy density in the entire power range. Volume normalized energy and power density also depends on the electrode density, which in turn depends on the function of the packing properties of the active material powder. Because smaller particles result in a reduction in electrode density, under similar calendering pressure the electrode density of 2.95 g/cc was achieved with the small particle material, compared to 3.52 g/cc obtained with the large particle material.

From the volume normalized Ragone plot of FIG. 11B, the penalty for low electrode density can be seen at low power. However, at higher power the gap in energy density is reduced and above a certain value it is fully closed. After that point, small and large particle materials have similar volumetric energy density. This trend demonstrates the benefit of small particles of active phase in high power applications. When very high discharge power is required, an improvement in rate capability of small particles more than compensates for lower packing density resulting in volumetric energy and power density on par with large particles of active phase, while still offering almost 50% improvement in gravimetric energy density. Lower electrode density is also indirect evidence for higher electrode porosity in small partiles materials responsible for better capacity retention at high discharge current.

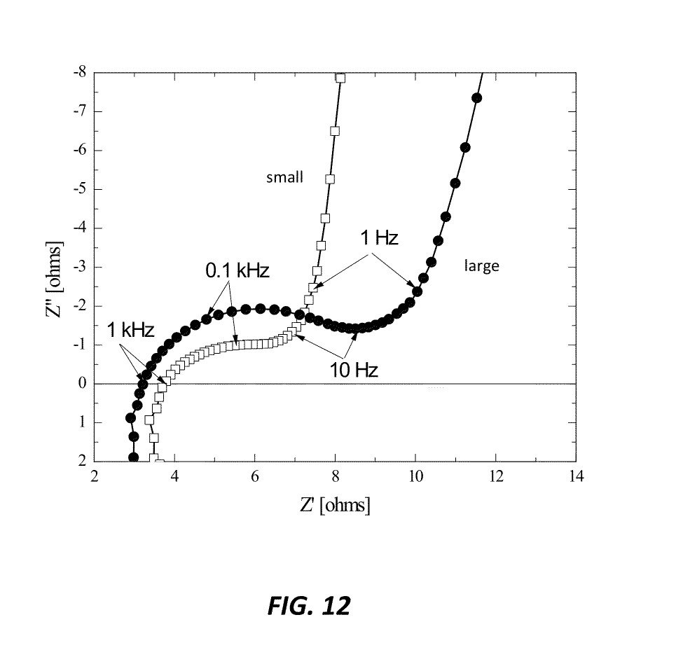

FIG. 12 shows electrochemical impedance spectra of formed and discharged coin-cells with either large or small sized particles measured in 1 MHz to 1mHZ frequency range with a signal amplitude of 10 mV (coin-cell area=1.77 cm²). In the discharged state, three main features can be observed: (1) a high frequency intercept with the real axis, which is indicative of electrolyte resistance (a constant identical for both coin-cells) plus electronic resistance of the electrode, and a charge transfer semi-circle, which is indicative of mass transport kinetics through the electrode; (2) at lower frequencies, Warburg diffusion then double-layer capacitance are observed, which reflects the blocking nature of the electrodes in the discharged state—in the case of small particle active materials, higher electronic resistance is observed because smaller particles have higher number of inter-particle connections; and (3) smaller charge transfer resistance is observed, attributed to the faster ionic diffusion of lithium ions inside the smaller porous particles made by RST. The latter feature results in the higher discharge rate capability observed with the small particle active materials.

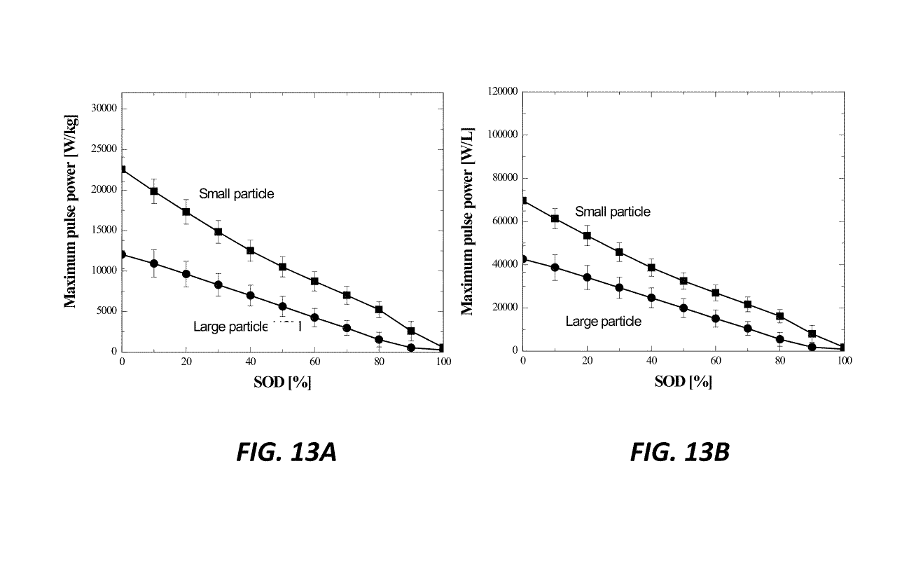

FIGS. 13A and 13B are plots, obtained from an HPPC test, of maximum pulse power versus State of Discharge (SOD) equal to 1-SOC (State of Charge), both mass (13A, gravimetric) and volume (13B, volumetric) normalized. The HPPC test was performed as described in “Battery Test Manual for Plug-In Hybrid Electric Vehicles,” Revision 0 (March 2008) published by U.S. Department of Energy, Vehicle Technologies Program. Discharge pulse was 5 C for 10 seconds, while charge pulse was 3.75 C for 10 second duration. From FIGS. 13A and 13B, it can be seen that small particle active materials are superior in delivering power from the cell in the entire range of state of discharge (SOD). The process of storing and releasing energy during the battery charge and discharge involves diffusion of Li inside the solid particles of electroactive material. Considering that solid state diffusion is typically much slower than diffusion of Li⁺ ions in the electrolyte phase, this causes small particles active materials to be better suited for power demanding applications.

### Example 3

This Example describes active materials comprising nickel-doped Mn spinels, a layer-layer Mn rich compositions, and their blends. All powders were prepared from an aqueous solution of nitrate precursors of Co, Ni, Mn and Li via RST, as described herein.

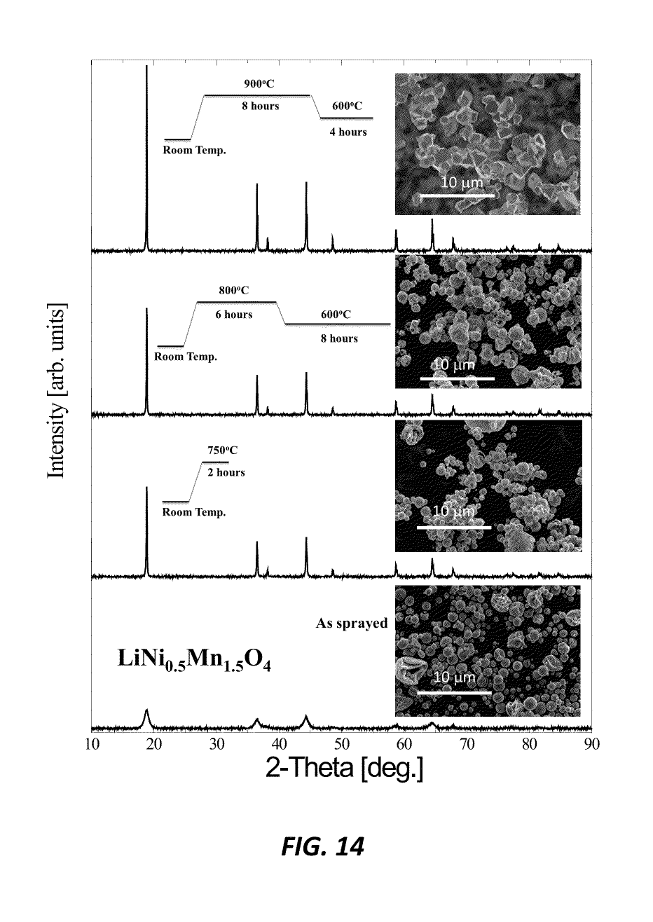

The as-sprayed spinel consists of spherical particles of ^{˜}1.5 μm D₅₀ diameter, and a BET surface area of 45 m²/g. Calcination was performed in air at 750° C./2 hr, or 800° C./6 hr then 600° C./8 hr or 900° C./8 hr then 600° C./4 hr. In the two step calcination, the second step is intended to recover oxygen lost at higher temperature in order to prevent the formation of oxygen deficient spinel. The left hand side of FIG. 14 shows XRD spectra of the spinel annealed at various temperatures. The right hand side of FIG. 14 shows the corresponding SEM images. FIG. 14 shows that the pure spinel phase is obtained directly as-sprayed at 750° C., but crystallinity is significantly improved by calcination. Rietveld refinement of a sample annealed at 900° C./8 hr then 600° C./4 hr indicates a primary crystal size of 187 nm, and lattice parameter a=8.171 Angstroms. The BET surface area drops to 0.71 m²/g at the 900° C. calcination temperature. SEM observation of the particles at various calcination temperatures reveals that the spherical morphology is preserved up to 800° C., but larger faceted crystals typical of spinel cathode materials are formed at 900° C. As-sprayed particles show some deflated spheres indicative of the rapid drying of droplets in the reactor. After calcination, the powders formed large hard aggregates.

Mn rich layer-layer samples of formula Li_{1.2}Ni_{0.2}Mn_{0.6}O₂, Li_{1.2}Ni_{0.3}Mn_{0.6}O_{2.2} and Li_{1.2}Ni_{0.133}Co_{0.133}Mn_{0.533}O₂ were prepared via ultrasonic spray pyrolysis from nitrate solutions of their metallic components. The as-sprayed powders had BET surface areas ranging from 84 to 62 m²/g, and D₅₀ particle diameters of ^{˜}1.6 μm. After calcination, their BET surface areas dropped to less than 7 m²/g and primary crystal sizes attained 75 nm for 16 h calcination at 900° C. The D₅₀ particle size only increased to 4 μm in the case of Li_{1.2}Ni_{0.2}Mn_{0.6}O₂. In the case of Co-doped formulations, a smaller BET surface area of 2.9 m²/g and a larger primary crystal size of 142 nm was observed after 16 h calcination at 900° C.

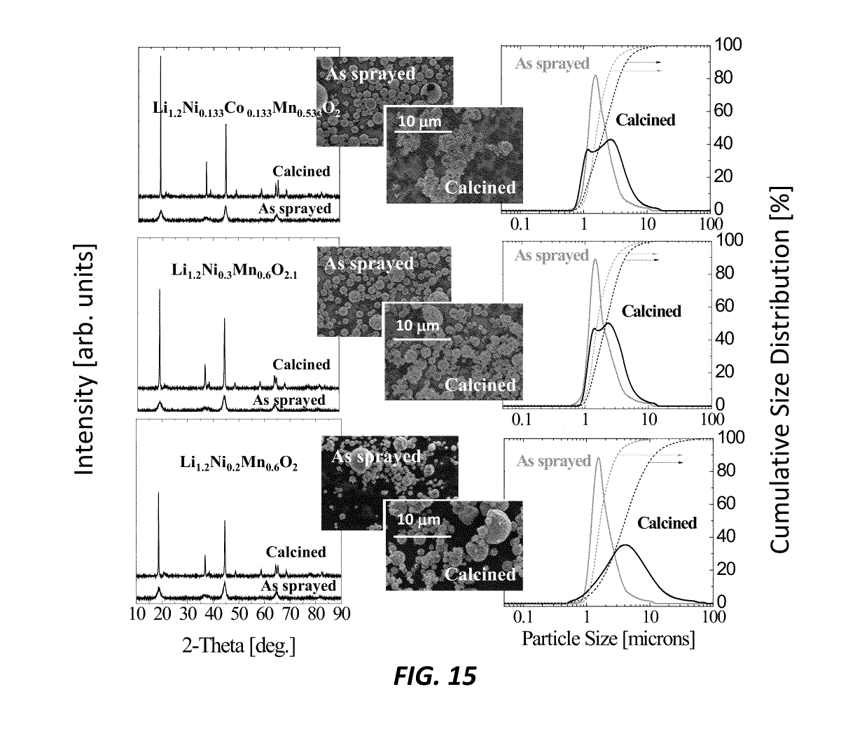

The left hand side of FIG. 15 shows XRD spectra of the as-sprayed powders and after 900° C./4 h calcination, indicating that pure phases are obtained directly after spraying whereas a calcination step is necessary to increase crystallinity. The middle portion of FIG. 15 has a series of SEM images of the samples before and after 900° C./4 h calcination, showing a spherical morphology that is preserved after calcination. Unlike the spinel, calcination does not result in significant aggregation of particles, and the as-sprayed particle size distribution is preserved after calcination, as seen in the right hand side of FIG. 15. As such, Mn-rich layer-layer powders could be incorporated directly into electrodes without any additional powder processing step.

Electrodes were prepared by mixing 82 wt. active materials, 5 wt. % Super P® conductive carbon black (TIMCAL Graphite and Carbon) 5 wt. % SFG6 graphite and 8 wt. % PVDF in NMP Solef 1031 using a Spex mill with two zirconia media for 30 min. Active materials were either 0.5Li₂MnO₃.0.5Li[NiMnCo]_{1/3} (layer-layer, D₅₀=2.1 μm), LiNi_{0.5}Mn_{1.5}O₄ (Spinel, D₅₀=1.5 μm), or a 1:1 mixture by weight of the two cathode powders. Slurries were doctor blade coated on Al foil (17 μm thickness) and dried at 80° C. The final active loading was 7.9 mg/cm². They were calendered and assembled into 2032 coin-cells using Li foil counter electrode and EC:DMC:EMC 1:1:1, VC1%, LiPF6 1M electrolytes. Cells were tested for capacity at various C-rates of discharge current in the same voltage range 2.0-4.8V

The initial charge/discharge capacities of the samples were measured in the 2.8-4.8 V potential range for spinel and 2.0-4.8 V potential range for layer-layer compositions. For layer-layer samples, the charging rate was C/10 to 4.8V, and discharging rates were 0.1 C, 0.2 C, 0.4 C, 0.8 C, 1.6 C and 3.2 C with 1 C discharge nominal capacity set to 250 mA/g. The cycle performances of the cathode powders at room temperature of 25° C. were measured at a constant current density of 0.5 C. Typically, four identical coin-cells per sample were measured to ensure data reproducibility, and the best of four is reported.

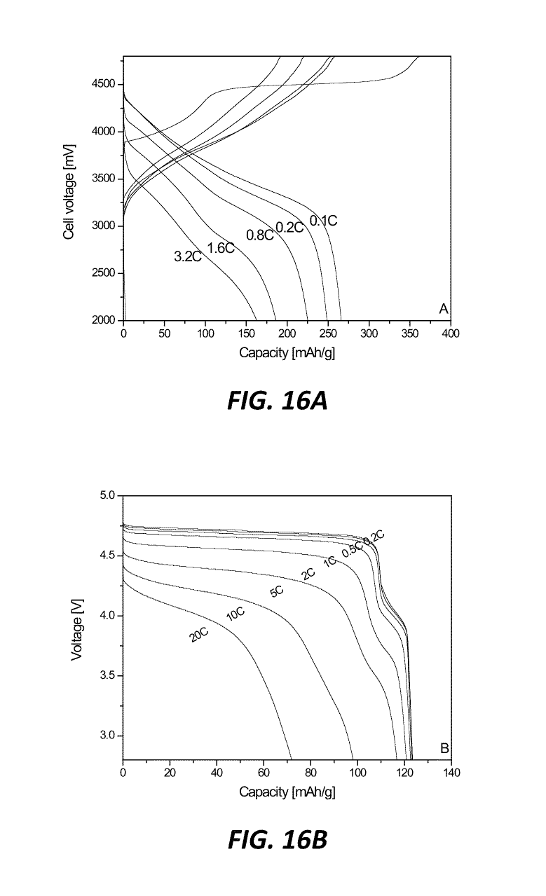

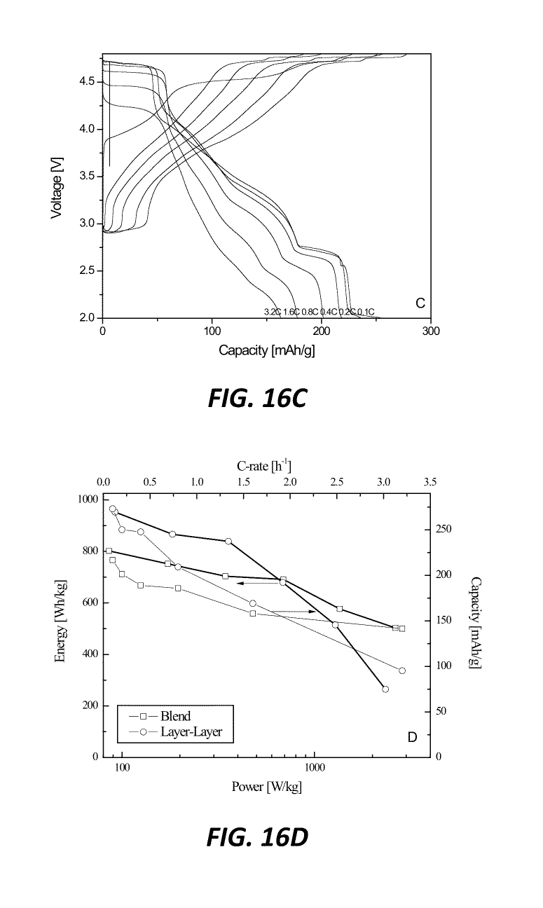

FIGS. 16A and 16B show that the layer-layer material has a higher capacity but a lower C-rate capability than the spinel. The 1:1 mixture of both display higher initial discharge voltage and lower capacity loss with C-rate (FIG. 16C). When plotting energy vs. power, the advantage of the mixture is captured: at slow discharge rate (0.1 C) the blend has a specific energy of 801 Wh/kg versus 952 Wh/kg for the standalone layer-layer. This is caused by the lower specific capacity of 217 mAh/g versus 273 mAh/g for the standalone layer-layer. However at faster discharge rate of 3.2 C, the blend has specific energy of 502 Wh/kg versus 264 Wh/kg for the standalone layer-layer cathode. At that rate, the capacity is 141 mAh/g which is similar to LiCoO₂, while it is down to 95 mAh/g for the standalone layer-layer cathode (FIG. 16D).

### Example 4

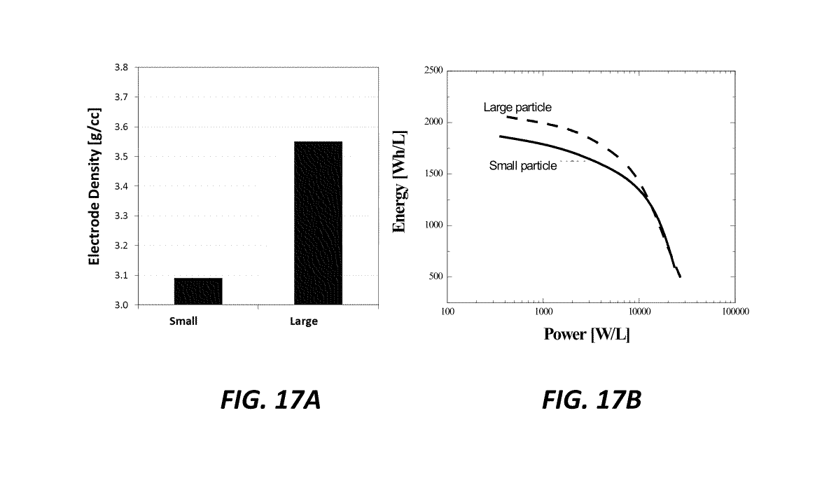

While cathodes incorporating small particle active materials can yield many improvements, as illustrated in Examples 1-3, certain applications may not benefit from the sole use of small particle materials. The electrochemical performance and electrode thickness after full calendaring was measured and used to calculate electrode density. FIG. 17A is a bar plot showing composite electrode density for the small and large particle active materials of Example 2. FIG. 17B is a plot of volumetric energy and power density of electrodes comprising small and large particle active materials. Smaller particles pack less densely, which in turn result in composite electrodes having lower densities compared to electrodes made from larger particles. When volumetric capacity is calculated by multiplying mass normalized energy with electrode density, larger active material particles produced in superior volumetric energy density, as demonstrated by FIG. 17B.

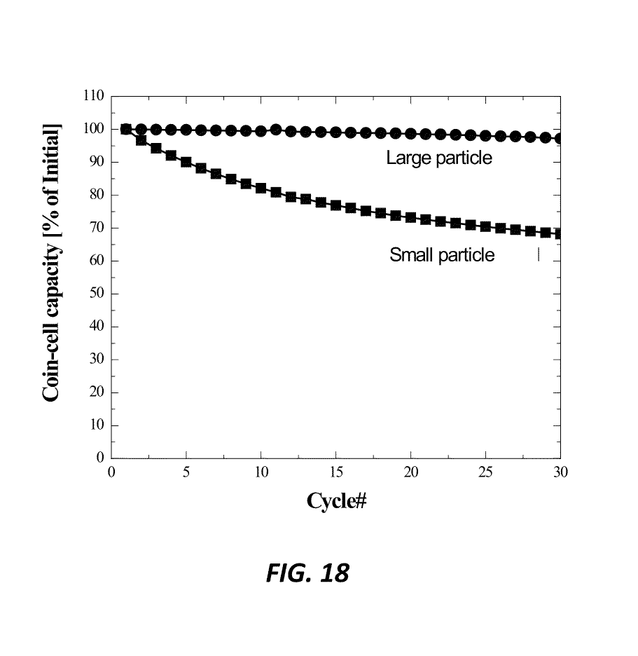

The electrodes were cycled at room temperature. FIG. 18 shows the results of cycling performance with a plot of capacity versus cycle number. While the initial 30 cycles for the large particle electrode did not show any signs of capacity fade, the electrode containing small particle active material showed a more pronounced decline and after 30 cycles they retained only 65% of their initial capacity. The problem of capacity deterioration with small particle active materials can be alleviated to some degree by controlling the upper cut-off voltage, i.e. SOC range, in which the active material is cycled. Thus, small particle active materials are typically used in partial state of charge applications, e.g., in HEV applications where the battery is cycled in a narrow state of charge window—below 100% to enable high discharge rates and regenerative power recovery.

Accordingly, this Example describes the preparation and testing of cathode formulations comprising blends of the small particle and large particle active materials described in Examples 1 and 2.

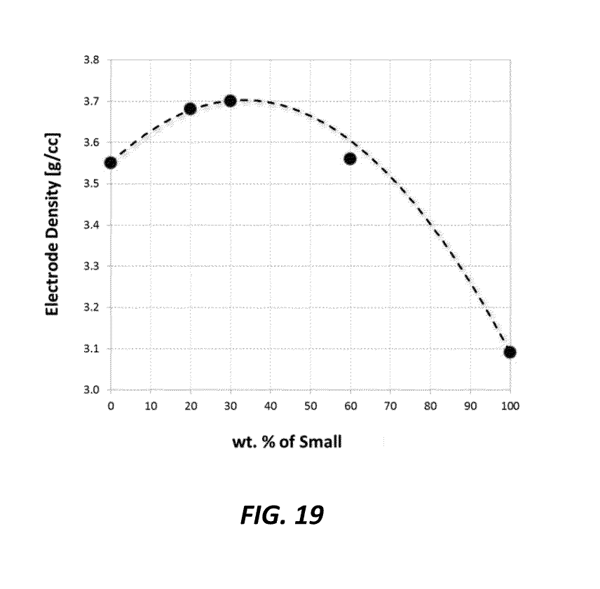

FIG. 19 is a plot of electrode density as a function of wt % small particle active material after full calendaring. The loading of small particle active material (wt % with respect to total weight of small and large particle active material) is varied from 0% to 100%, where 0 wt % represents a large particle-only formulation, and 100 wt % represents a small particle-only formulation. It can be seen that as the weight % of small particle size active material increases, the overall electrode density increases. Without wishing to be bound by any theory, it is believed that the density increase is due to the packing of smaller particles in voids created by the packing of larger particles. The small particles minimally distribute the packing density of the large particles while adding active mass in the void space between those particles. However, the void volume created by larger particles is limited and determined by random packing of spherical particles. At higher volume fractions, the small particles cannot be accommodated and may even disrupt the packing density of larger particles, resulting in a decrease in electrode density after achieving a maximum value. As seen in FIG. 19, for LiNi_{0.33}CO_{0.33}Mn_{0.33}O₂ particles having the size as listed in Table 3, blending 40% by weight of small particle active material with 60% by weight of large particle material achieves a greater electrode density compared to the large particle-only formulation. Moreover, the resulting composite electrode has an electrochemically active surface area of 1.62 m²/g compared to 0.3 m²/g with a large particle-only formulation. This increased surface area is expected to be beneficial for power performance.

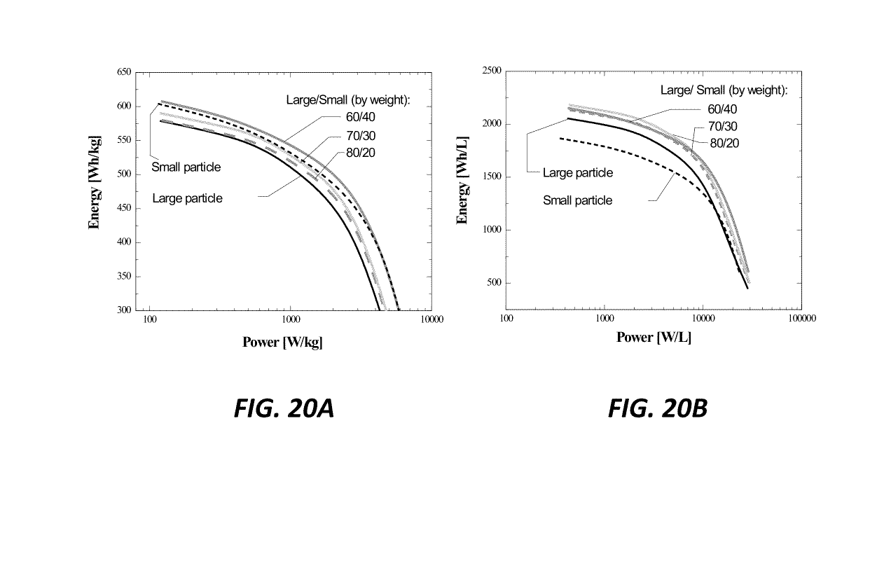

FIGS. 20A and 20B show mass normalized (20A) and volume normalized (20B) Ragone plots for pure small and large particle cathode formulations and their blends and the effect on power performance, i.e. gravimetric energy and power density. The power performance value is indicative of active material utilization, which in turn is a function of the size of active particles. All blends show performance between energy/power performance of either large or small particle materials, and depending on the blending ratio they are closer to one or the other. The blend of 60/40 large/small particle blend showed improved gravimetric energy and power density over both grades individually, a result that was unexpected and surprising. When mass normalized energy and power density is multiplied with electrode density to obtain volumetric energy and power density, the benefits of the blending approach can be seen.

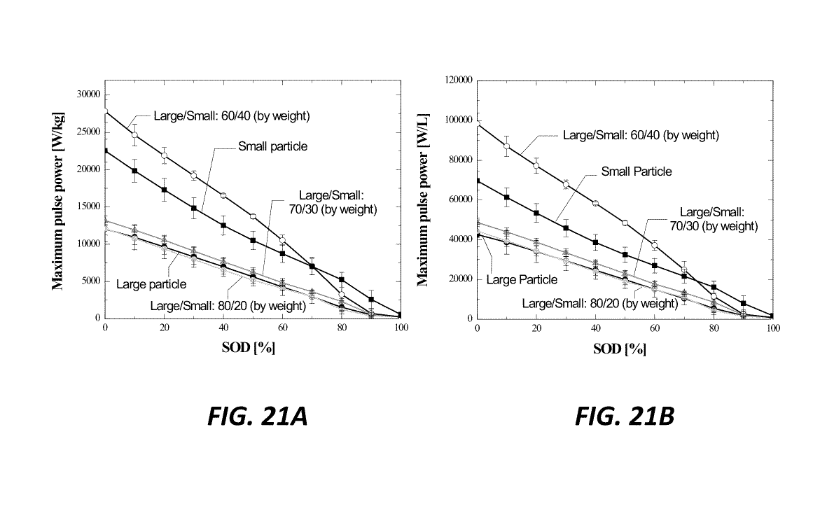

All blends show improvement in both volume normalized energy and power over respective pure grades. FIGS. 21A and 21B show plots of mass normalized (21A) and volume normalized (21B) maximum discharge power obtained from pulsed HPPC tests as a function of State of Charge (SOC). Unexpected behavior observed in continuous discharge was confirmed and even magnified when maximum discharge power rate was measured during a pulsed (HPPC) discharge regime. In this case there is obviously a synergistic effect seen with the blended formulation that surpasses the performance of either of them individually. This benefit is even more magnified after electrode volume normalization of energy and power performance.

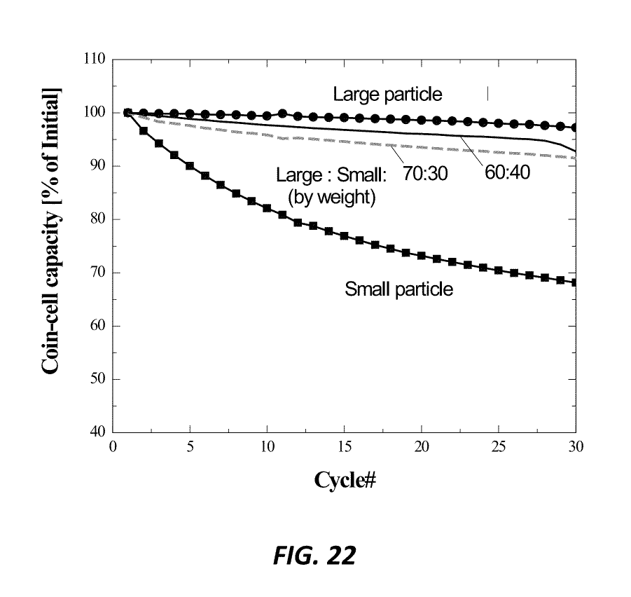

The impact of the blends on cycle life performance was evaluated; this data is plotted in FIG. 22, which shows coin-cell capacity (% of initial) as a function of cycle number. All blends showed a cycle life performance significantly better than that of the small particle formulation and comparable to that of the large particle formulation.

In summary, the use of blends results in improved volumetric energy and power density, with specific blending ratio resulting in synergy that ultimately increased gravimetric energy and power in addition to volumetric energy and power density. All blends resulted in cycle life performance comparable to more stable large particle morphology, thus enabling applications utilizing full depth of discharge.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A cathode formulation comprising:
a first lithium ion-based electroactive material having a particle size distribution of 1 μm≦D₅₀≦5 μm; and
a second lithium ion-based electroactive material having a particle size distribution of 5 μm<D₅₀≦15 μm;
wherein the maximum pulse power in W/kg and W/L of the mixture is higher than maximum pulse power of the first or second electroactive material individually.

2. A cathode formulation comprising:
a first lithium ion-based electroactive material having a particle size distribution of 1 μm≦D₅₀≦5 μm; and
a second lithium ion-based electroactive material having a particle size distribution of 5 μm<D₅₀≦15 μm;
wherein the energy density in Wh/kg and Wh/L of the mixture is higher than energy density of the first or second electroactive material individually.

3. A cathode formulation comprising:
a first lithium ion-based electroactive material having a particle size distribution of 1 μm≦D₅₀≦5 μm;
a second lithium ion-based electroactive material having a particle size distribution of 5 μm<D₅₀≦15 μm; and
carbon black having BET surface area ranging from 130 to 700 m²/g.

4. The cathode formulation of claim 3, wherein the first electroactive material has a particle size distribution of 1 μm≦D₅₀≦5 μm, and the second electroactive material has a particle size distribution of 6 μm≦D₅₀≦15 μm.

5-6. (canceled)

7. The cathode formulation of claim 3, wherein the first electroactive material has a pore size of less than 15 nm.

8. (canceled)

9. The cathode formulation of claim 3, wherein the first electroactive material has a single point adsorption total pore volume of at least 0.002 cm³/g.

10. The cathode formulation of claim 3, wherein a spherical radius of the second electroactive material particle is less than or equal to 0.4 the spherical radius of the first electroactive material particle.

11. (canceled)

12. The cathode formulation of claim 3, wherein the BET surface area ranges from 130 to 300 m²/g.

13. The cathode formulation of claim 3, wherein the carbon black has an OAN ranging from 100 mL/100 g to 300 mL/100 g.

14. (canceled)

15. The cathode formulation of claim 3, wherein the carbon black is present in the formulation in an amount ranging from 0.1% to 10% by weight, relative to the total weight of the formulation.

16. (canceled)

17. The cathode formulation of claim 3, wherein the carbon black has a crystallinity (I_{D}/I_{G}) of at least 25%, as determined by Raman spectroscopy.

18-19. (canceled)

20. The cathode formulation of claim 3, wherein the carbon black has a crystallite size (Lₐ) of at least 30 Å, as determined by Raman spectroscopy.

21-22. (canceled)

23. The cathode formulation of claim 3, wherein the carbon black has a surface energy less than or equal to 10 mJ/m².

24-25. (canceled)

26. The cathode formulation of claim 3, wherein the first and second electroactive materials are present in the cathode formulation in a sum of at least 80% by weight, relative to the total weight of the cathode formulation.

27. The cathode formulation of claim 3, wherein the carbon black is a heat-treated carbon black.

28. The cathode formulation of claim 27, wherein the carbon black has been heat-treated at a temperature of at least 1000° C.

29-30. (canceled)

31. The cathode formulation of claim 3, wherein the electroactive material is selected from:
LiMPO₄, wherein M represents one or more metals selected from Fe, Mn, Co, and Ni;
LiM′O₂, wherein M′ represents one or more metals selected from Ni, Mn, Co, Al, Mg, Ti, V, Cr, Fe, Zr, Ga, and Si;
Li(M″)₂O₄, wherein M″ represents one or more metals selected from Ni, Mn, Co, Al, Mg, Ti, V, Cr, Fe, Zr, Ga, and Si; and
Li₁₊ₓ(Ni_{y}Co_{1-y-z}Mn_{z})₁₋ₓO₂, wherein x ranges from 0 to 1, y ranges from 0 to 1 and z ranges from 0 to 1.

32. The cathode formulation of claim 3, wherein the electroactive material is selected from at least one of LiNiO₂; LiNiₓAl_{y}O₂ where x varies from 0.8-0.99, y varies from 0.01-0.2, and x+y=1; LiCoO₂; LiMn₂O₄; Li₂MnO₃; LiNi_{0.5}Mn_{1.5}O₄; LiFeₓMn_{y}Co_{z}PO₄ where x varies from 0.01-1, y varies from 0.01-1, z varies from 0.01-0.2, and x+y+z=1; LiNi_{1-x-y}MnₓCo_{y}O₂, wherein x ranges from 0.01 to 0.99 and y ranges from 0.01 to 0.99; and layer-layer compositions containing an Li₂MnO₃ phase or a LiMn₂O₃ phase.

33. The cathode formulation of claim 3, wherein the electroactive material is selected from at least one of Li₂MnO₃; LiNi_{1-x-y}MnₓCo_{y}O₂ wherein x ranges from 0.01 to 0.99 and y ranges from 0.01 to 0.99; LiNi_{0.5}Mn_{1.5}O₄; Li₁₊ₓ(Ni_{y}Co_{1-y-z}Mn_{z})₁₋ₓO₂, wherein x ranges from 0 to 1, y ranges from 0 to 1 and z ranges from 0 to 1; and layer-layer compositions containing at least one of an Li₂MnO₃ phase and an LiMn₂O₃ phase.

34. The cathode formulation of claim 3, wherein:
the first electroactive material has the formula aLi₂MnO₃:(1−a)LiMO₂, wherein a ranges from 0.1 to 0.9 and M is one or more metals selected from Mn, Ni, and Co; and
the second electroactive material has the formula LiNi_{0.5}Mn_{1.5}O₄.

35. The cathode formulation of claim 3, wherein the second electroactive material is present in an amount ranging from 10 wt % to 50 wt %, relative to the total weight of the electroactive material.

36. The cathode formulation of claim 3, wherein the electroactive material is prepared by a spray process.

37. The cathode formulation of claim 3, wherein the carbon black is homogeneously interspersed with the lithium-ion based material.

38. The cathode formulation of claim 3, further comprising a binder.

39. (canceled)

40. A cathode comprising the cathode formulation of claim 3.

41. (canceled)

42. An electrochemical cell comprising the cathode of claim 40.

43. (canceled)

44. A method of making a cathode, comprising:
combining particles comprising carbon black, a lithium ion-based electroactive material, and a binder in the presence of a solvent to produce a paste;
depositing the paste onto a substrate; and
forming the cathode,
wherein the lithium ion-based electroactive material comprises:
a first lithium ion-based electroactive material having a particle size distribution of 1 μm≦D₅₀≦5 μm; and
a second lithium ion-based electroactive material having a particle size distribution of 5 μm<D₅₀≦15 μm.

45. The method of claim 44, wherein the forming comprises removing the solvent.

46. A cathode formulation comprising:
a lithium ion-based electroactive material having a D₅₀ ranging from 1 μm to 6 μm; and
carbon black having BET surface area ranging from 130 to 700 m2/g and an OAN ranging from 150 mL/100 g to 300 mL/100 g.

47-48. (canceled)

49. The cathode formulation of claim 46 wherein the carbon black has a BET surface area ranging from 130 to 300 m²/g.

50. The cathode formulation of claim 46 wherein the carbon black has an OAN of less than 250 mL/100 g.

51-55. (canceled)

56. The cathode formulation of claim 46 wherein the electroactive material comprises a first electroactive material having a D₅₀ ranging from 1 μm to 6 μm and a second electroactive material having a D50 ranging from 1 μm to 5 μm.

57. The cathode formulation of claim 46 wherein the surface area ratio of carbon black to electroactive material ranges from 1 to 5.

58-86. (canceled)

87. A method of making a cathode, comprising:
combining particles comprising carbon black, a lithium ion-based electroactive material, and a binder in the presence of a solvent to produce a paste;
depositing the paste onto a substrate; and
forming the cathode,
wherein the electroactive material has a D50 ranging from 1 μm to 6 μm, and the carbon black has a BET surface area ranging from 130 to 700 m²/g and an OAN ranging from 150 mL/100 g to 300 mL/100 g.

88. (canceled)
